(19) United States
(12) Patent Application Publication
(10) Pub. No.: US 2017/0331235 A1
(43) Pub. Date: Nov. 16, 2017

(54) CONNECTOR

(71) Applicants: JAPAN AVIATION ELECTRONICS INDUSTRY, LIMITED, Tokyo (JP); JAE Hong Kong, Ltd., Kowloon, Hong Kong (CN)

(72) Inventors: Yohei YOKOYAMA, Tokyo (JP); Yuichi SAITO, Tokyo (JP); Rintaro KATO, Kowloon, Hong Kong (CN)

(73) Assignees: JAPAN AVIATION ELECTRONICS INDUSTRY, LIMITED, Tokyo (JP); JAE Hong Kong, Ltd., Kowloon, Hong Kong (CN)

(21) Appl. No.: 15/526,054

(22) PCT Filed: Jun. 24, 2015
(86) PCT No.: PCT/JP2015/068226

§ 371 Date: May 11, 2017

(30) Foreign Application Priority Data
Nov. 18, 2014 (JP) 2014-233685

(51) Int. Cl. H01R 24/50; H01R 13/504

(52) U.S. Cl. CPC H01R 24/50; H01R 13/5045

(57) ABSTRACT

Provided is a connector including: a body forming component into which an upper contact group and a lower contact group are press-fitted forward in a fitting direction; and an upper contact insert component formed integrally with the upper contact group through insert molding. The upper contact insert component is arranged behind the lower contact group.

### TECHNICAL FIELD

This invention relates to a connector configured to electrically connect one connection object, which is a flat-plate-like signal transmission medium, to another connection object, and more particularly, to a connector including a plurality of contacts arranged on each of two parallel planes.

### BACKGROUND ART

As a connector of this type, for example, a universal serial bus (USB) standard connector and a high definition multimedia interface (HDMI) (trademark) standard connector have been known. The related-art connectors of this type are disclosed in, for example, Patent Document 1.

In this specification, directions relating to a connector are defined as follows. A direction of removing a mating connector, which is fitted in advance to a subject connector from the subject connector, is indicated by D1. A moving direction of the mating connector toward the subject connector when the mating connector is to be fitted to the subject connector is indicated by D2, which is reverse to D1. A direction of mounting the subject connector to a board is indicated by D3. A direction reverse to the direction of D3 is indicated by D4. When D1, D2, D3, and D4 indicate forward, rearward, upward, and downward directions from the connector, respectively, a leftward direction of the connector is indicated by D5, and a rightward direction of the connector is indicated by D6. With regard to the directions relating to the connector, FIG. 1 and the like are to be referred.

As illustrated in FIG. 16, a connector 300 disclosed in Patent Document 1 includes a shell 301, a body forming component (referred to as “connector housing” in Patent Document 1) 302, a lower contact group 303, and an upper contact group 304 (the contact groups being referred to as “terminals” in Patent Document 1). The body forming component 302 includes a terminal support 306 horizontally protruding from a base 305. A plurality of terminal insertion holes 307 are formed in a joint portion of an upper surface of the terminal support 306 so as to pass through the base 305 and extend along the upper surface of the terminal support 306. Contacts of the upper contact group 304 are press-fitted into the terminal insertion holes 307 and arranged in parallel to each other at predetermined pitches on the upper surface (surface on the direction D3 side) of the terminal support 306. Similarly, a plurality of terminal insertion holes 308 (not shown) are formed in a joint portion of a lower surface (surface on the direction D4 side) (not shown) of the terminal support 306 so as to pass through the base 305 and extend along the terminal support 306. Contacts of the lower contact group 303 are press-fitted into the terminal insertion holes 308 and arranged in parallel to each other at predetermined pitches an the lower surface of the terminal support 306. As described above, in the connector 300 disclosed in Patent Document 1, the contacts of the lower contact group 303 and the contacts of the upper contact group 304 are retained at predetermined positions in the connector 300 by being press-fitted into the terminal insertion holes 307 and 308.

In addition, in Patent Document 1, as illustrated in FIG. 17, a locking projecting portion 312 is formed on a portion of each of the contacts, which are retained in the terminal insertion holes 307 and 308 when the contacts of the lower contact group 303 and the contacts of the upper contact group 304 are press-fitted into the body forming component 302. That is, the locking projecting portion 312 is formed on a lower surface of a press-fitted portion 311 of each of the contacts. With this configuration, the connector 300 increases a retaining force applied between the press-fitted portion 311 and a lower wall surface among four wall surfaces surrounding upper, lower, right, and left sides of each of the terminal insertion holes 307 and 308.

Further, as illustrated in FIG. 18, protruding portions 313 are formed on both side surfaces of the press-fitted portion 311. With this configuration, the connector 300 increases a retaining force applied between each of left and right wall surfaces 314 and 315 of each terminal insertion hole 307 and each side surface of the contact of the lower contact group 303 or the upper contact group 304.

### PRIOR ART DOCUMENTS

### Patent Document

Patent Document 1: JP-A-2011-113801, paragraphs 0017 to 0023, paragraphs 0028 to 0030, FIG. 2, and FIG. 8

### DISCLOSURE OF THE INVENTION

### Problem to be Solved by the Invention

In the connector disclosed in Patent Document 1, the locking projecting portions 312 and the protruding portions 313 are formed to increase the retaining force. However, the retaining force for each contact is increased individually. Accordingly, in the connector disclosed in Patent Document 1, the retaining forces for the individual contacts may vary.

In general, when the connector is to be fitted to the mating connector, contacts of the mating connector apply forces of pushing the contacts of the connector in the direction D2. Even when it is assumed that the contacts of the mating connector evenly apply forces to the contacts of the connector, the retaining forces for the respective contacts may vary in the connector disclosed in Patent Document 1. Thus, there is a fear in that a contact retained with a weak force may be moved in the direction D2 from an originally retained position. In addition, there is a fear in that the contact is not only moved but also buckled as a result of movement, and there is also a fear in that the contact slips out of the body forming component. In actuality, the forces applied by the contacts of the mating connector to the contacts of the connector are not even and may vary. Accordingly, there is a case where a strong pushing force is applied to a contact retained with a weak force. In such a case, the influence of the pushing force applied from the contacts of the mating connector during fitting may become more significant.

This invention has been made in view of the above-mentioned circumstances, and has an object to increase retaining forces of retaining a plurality of contacts.

### Means to Solve the Problem

In order to solve the above-mentioned problem, this invention provides, as one aspect, a connector, comprising an upper contact group comprising a plurality of contacts; a lower contact group comprising a plurality of contacts; a body forming component into which the upper contact group and the lower contact group are press-fitted; and an upper contact insert component including a dielectric material and being formed integrally with the upper contact group through insert molding, each of the plurality of contacts being arranged in parallel to a fitting direction of fitting the connector to a mating connector, and comprising a contact portion that is to be brought into contact with one of contacts of the mating, connector; a press-fitted portion that extends from the contact portion and is to be press-fitted into the body forming component; a terminal portion that is to be connected to a conductor arranged outside the connector; and a bent portion that is bent between the contact portion and the terminal portion in a direction intersecting the fitting direction, the each of the plurality of contacts being press-fitted into the body forming component in a direction of removing the mating connector, which is fitted to the connector in advance, from the connector, the body forming component supporting the plurality of contacts of the lower contact group so as to arrange the contact portion of the each of the plurality of contacts of the lower contact group on a first plane, and supporting the plurality of contacts of the upper contact group so as to arrange the contact portion of the each of the plurality of contacts of the upper contact group on a second plane different from the first plane, and the upper contact insert component being arranged so as to restrain movement of the lower contact group in a moving direction of the mating connector toward the connector when the mating connector and the connector are to be fitted to each other.

As seen from the bent portion of the each of the plurality of contacts of the lower contact group, the upper contact insert component may be arranged on a forward side of the moving direction of the mating connector toward the connector when the mating connector and the connector are to be fitted to each other.

The each of the plurality of contacts of the upper contact group may comprise a leg portion extending in the direction intersecting the fitting direction, and at least a part of the upper contact insert component may occupy a region surrounded by a straight line formed of the contact portion, the bent portion, and a straight line formed of the leg portion.

A gap having a preset size may be defined between the upper contact insert component and the lower contact group.

The body forming component may further comprise a middle plate that comprises metal and is formed integrally with the body forming component through insert molding so as to be arranged between the upper contact group and the lower contact group.

The connector may further comprise a rear shield including metal and the body forming component may comprise a fixing portion configured to fix the rear shield under a state in which the upper contact insert component is arranged between the rear shield and the body forming component.

The connector may further comprise a protrusion formed on one surface of the upper contact insert component on the forward side of the moving direction of the mating connector toward the connector when the mating connector and the connector are to be fitted to each other so as to come into contact with the rear shield.

The connector may further comprise a shell at least a part of which is formed of a conductor, and the shell and the rear shield may be welded to each other.

### Effect of the Invention

According to one aspect of this invention, the plurality of contacts of the upper contact group are integrated by the upper contact insert component. Thus, a sum of retaining forces for all of the contacts bears forces applied to the respective contacts. Further, the upper contact insert component supports the lower contact group from behind the lower contact group, thereby preventing the lower contact group from slipping out of the body forming component. Therefore, according to one aspect of this invention, the retaining forces for all of the integrated contacts of the upper contact group and the retaining forces for all of the contacts of the lower contact group supported from behind can be increased.

### BRIEF DESCRIPTION OF THE DRAWING

FIG. 1 is an exploded perspective view of a connector 1 according to one embodiment of this invention.

FIG. 2 is a perspective view of a shell 2 of the connector 1.

FIG. 3 is a perspective view of a body forming component 6 of the connector 1, which is formed integrally with a middle plate 5.

FIG. 4 is a sectional view of the body forming component 6 of the connector 1 before contacts 50 are press-fitted into the body forming component 6.

FIG. 5 is a perspective view for illustrating a shape of one of the contacts 50 of the connector 1.

FIG. 6 is a perspective view for illustrating an upper contact insert component 9 of the connector 1, which is formed integrally with an upper contact group 8.

FIG. 7 is a sectional side view of the connector 1.

FIG. 8 is a sectional perspective view for illustrating a positional relationship in the connector 1 among rear ends 56 of a lower contact group 7, the upper contact insert component 9, and a rear shield 10.

FIG. 9 is a perspective view for illustrating mounting of the rear shield 10 in the connector 1.

FIG. 10 is a perspective view for illustrating the connector 1 after mounting of the rear shield 10.

FIG. 11 is a perspective view of the connector 1.

FIG. 12 is a perspective view of the connector 1.

FIG. 13 shows the connector 1 as seen from six sides.

FIG. 14 is an exploded perspective view of a connector 200 according to a second embodiment of this invention.

FIG. 15 is a sectional view of the connector 200.

FIG. 16 is an exploded perspective view of a connector 300 disclosed in Patent Document 1.

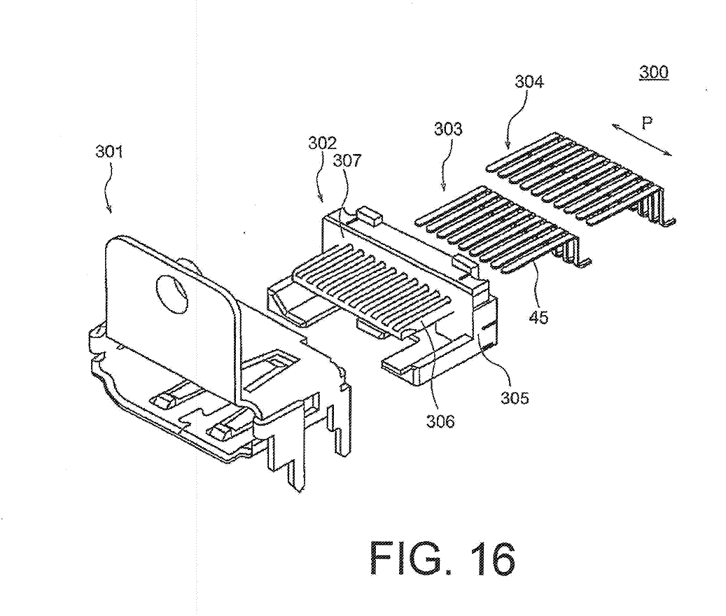

FIG. 17 is a partial sectional view of the connector 300.

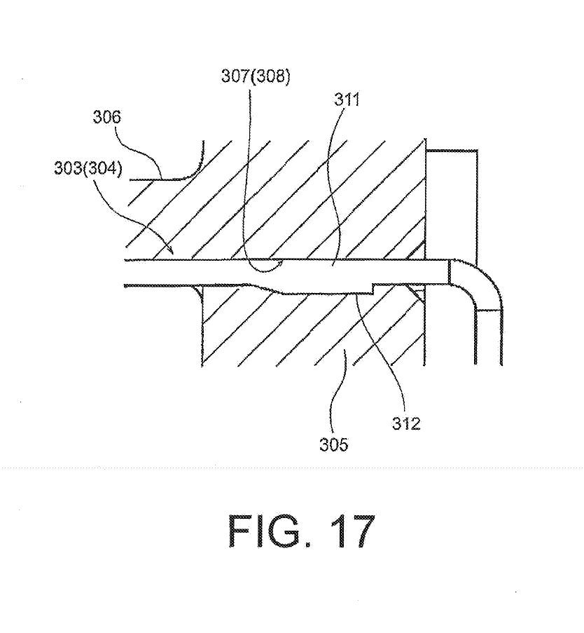

FIG. 18 is a partial sectional view of the connector 300.

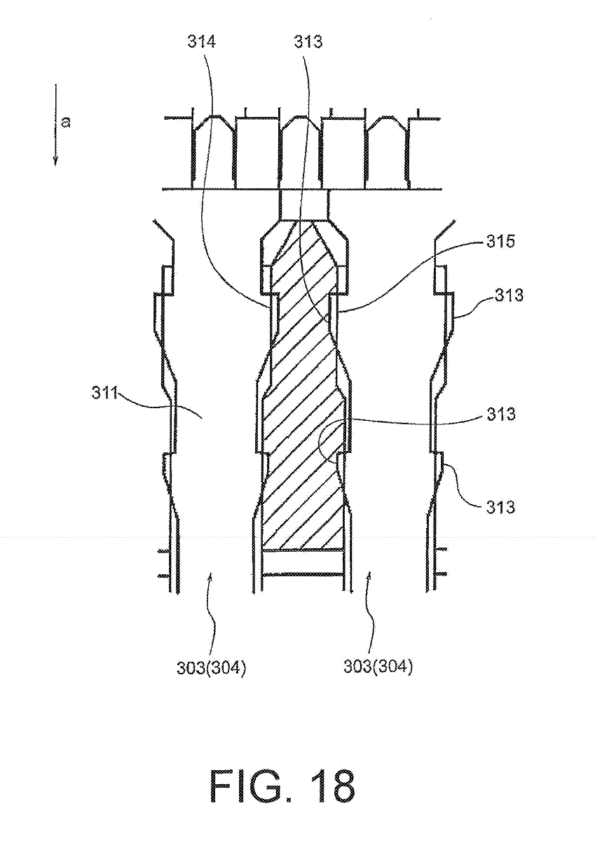

### MODES FOR EMBODYING THE INVENTION

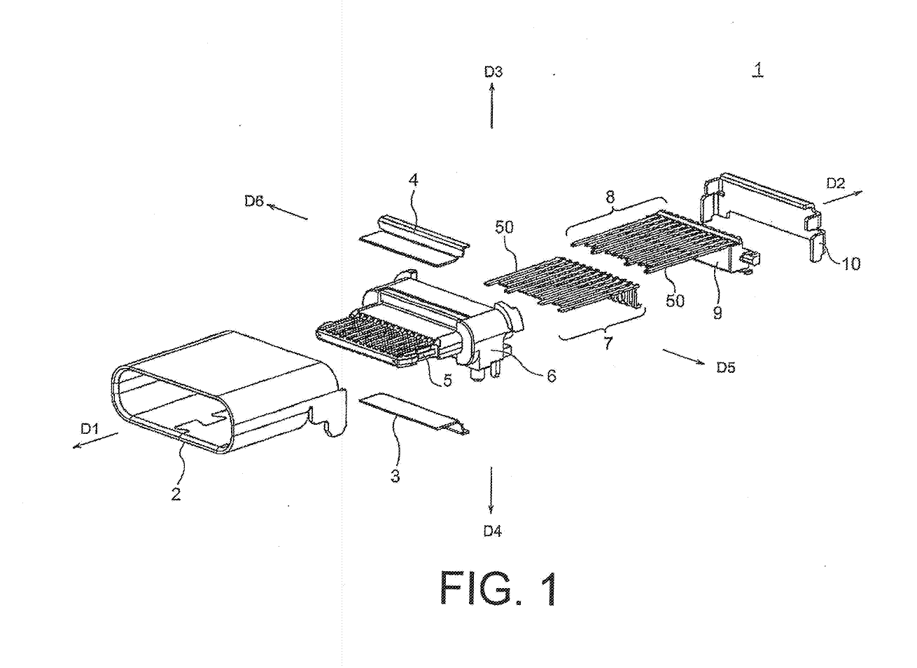

A connector 1 according to one embodiment of this invention is described. With reference to FIG. 1, the connector 1 includes a shell 2, ground plates 3 and 4, a middle plate 5, a body forming component 6, a lower contact group 7, an upper contact group 8, an upper contact insert component 9, and a rear shield 10.

At least a part of each of the shell 2, the ground plates 3 and 4, the middle plate 5, and the rear shield 10 is made of a conductor, which is typically metal. For example, the shell 2, the ground plates 3 and 4, the middle plate 5, and the rear shield 10 are entirely made of stainless steel such as SUS301 or SUS304. Contacts 50 of the lower contact group 7 and contacts 50 of the upper contact group 8 are made of a conductor such as metal, for example, a copper alloy. The body forming component 6 and the upper contact insert component 9 are made of a resin. For example, the body forming component 6 is made of a polyamide resin, and the upper contact insert component 9 is made of a liquid crystal polymer (LCP).

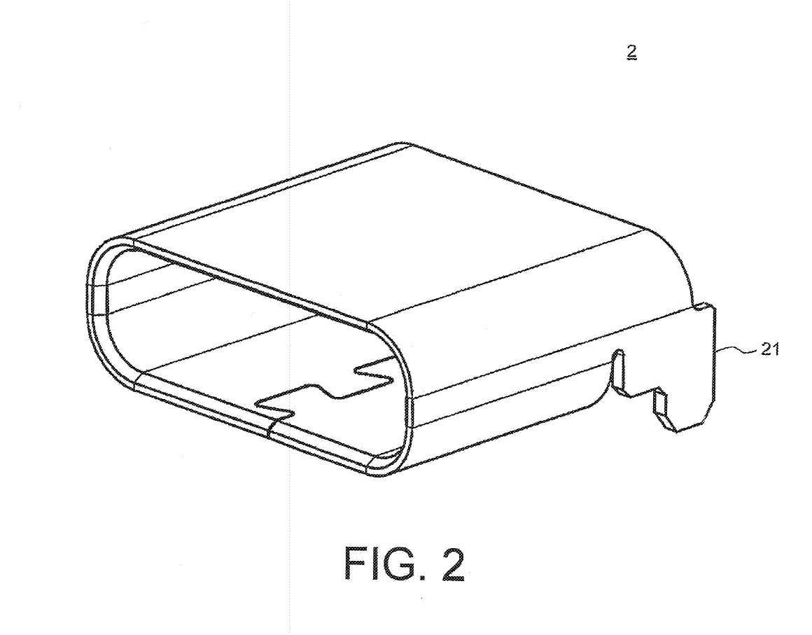

The shell 2 is described with reference to FIG. 2. The shell 2 has a tubular shape formed of a hollow quadrangular parallelepiped column with rounded corners, except for a rear end (end on the direction D2 side) thereof. The shell 2 includes a fixing leg portion 21 which is formed at a left rear end (end on the direction D2 side and the direction D5 side) of the shell 2. Similarly, the shell 2 includes a fixing leg portion 22 which is formed at a right rear end (end on the direction D2 side and the direction D6 side) of the shell 2 though the fixing leg portion 22 is hidden behind the shell 2 in FIG. 2.

When the connector 1 is to be placed on a board (not shown), a bottom surface of the shell 2 is brought into contact with the board, and distal ends of the fixing leg portions 21 and 22 are inserted into holes formed in the board, respectively, and are soldered to the board. In this manner, the entire connector 1 is fixed to the board. Further, the distal ends of the fixing leg portions 21 and 22 are connected to grounding conductors (not shown) formed on the board. In this manner, the entire shell 2 is electrically grounded.

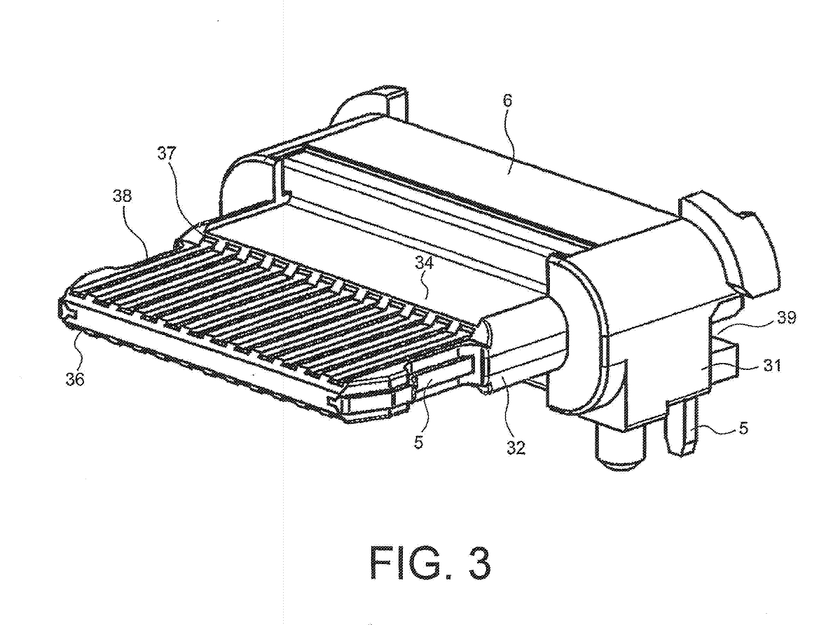

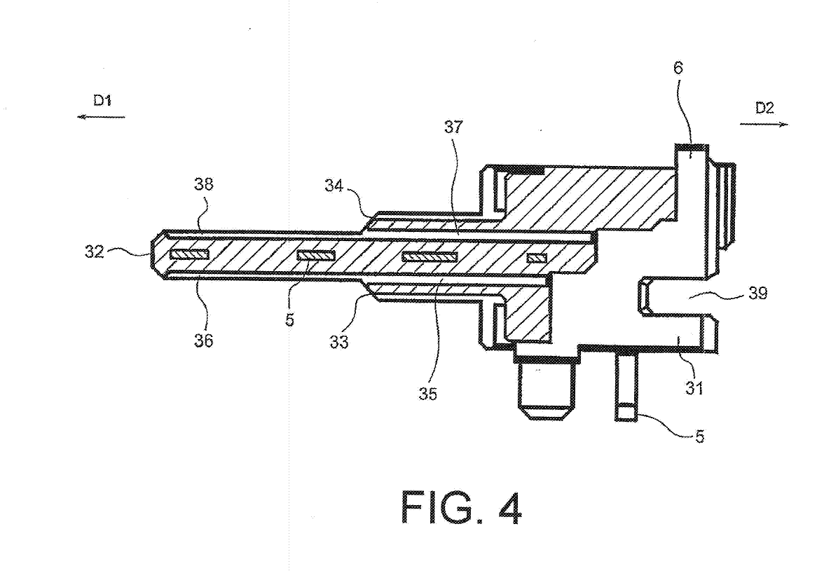

The middle plate 5 and the body forming component 6 are described with reference to FIG. 3 and FIG. 4. The middle plate 5 and the body forming component 6 are formed integrally with each other through insert molding.

The body forming component 6 includes a base 31 that is fixed to the board when the connector 1 is to be placed on the board. A terminal support 32 extends from the base 31 forward in a horizontal direction, that is, extends along a plane parallel to the board in the direction D1. A plate support 33 (not shown in FIG. 3), on which the ground plate 3 is to be mounted, is formed on a lower surface of a rear portion of the terminal support 32. Similarly, a plate support 34, on which the ground plate 4 is to be mounted, is formed on an upper surface of the rear portion of the terminal support 32. The ground plates 3 and 4 are brought into contact with the shell 2 inside the shell 2. As described above, the shell 2 is grounded, and hence the ground plates 3 and 4 are grounded through the shell 2. Accordingly, the lower contact group 7 and the upper contact group 8 are electromagnetically insulated from an outside of the shell 2 by the shell 2 and the ground plates 3 and 4.

Further, in order to retain the lower contact group 7 and the upper contact group 8, the body forming component 6 has lower terminal insertion holes 35, lower terminal retention grooves 36, upper terminal insertion holes 37, and upper terminal retention grooves 38 formed therein. The lower terminal insertion holes 35 and the lower terminal retention grooves 36 retain the respective contacts of the lower contact group 7 so as to arrange the respective contacts of the lower contact group 7 on an imaginary plane P1 (not shown). The upper terminal insertion holes 37 and the upper terminal retention grooves 38 retain the respective contacts of the upper contact group 8 so as to arrange the respective contacts of the upper contact group 8 on an imaginary plane P2 (not shown). The plane P1 and the plane P2 are parallel to each other, and are parallel to the board (not shown).

As illustrated in the drawings, the upper terminal insertion holes 37 pass through the base 31 from openings (not shown) formed in a rear portion of the body forming component 6, and further pass through a portion of the terminal support 32 below the plate support 34 so as to linearly continue to the upper terminal retention grooves 38, respectively. The upper terminal insertion holes 37 and the upper terminal retention grooves 38 each have a width slightly smaller than a width of each of the contacts 50 of the upper contact group 8. Accordingly, the contacts 50 press-fitted into the upper terminal insertion holes 37 and the upper terminal retention grooves 38 are retained by the body forming component 6. The same holds true for the lower terminal insertion holes 35 and the lower terminal retention grooves 36.

The middle plate 5 is exposed from a distal end and both right and left side surfaces of the terminal support 32. Further, although not shown, the middle plate 5 is bent inside the body forming component 6, and an end of the middle plate 5 is exposed from a lower portion of the base 31. The portion exposed from the base 31 is soldered and connected to a grounding conductor of the board when the connector 1 is placed on the board (not shown). Thus, the middle plate 5 can electromagnetically insulate the lower contact group 7 and the upper contact group 8 from each other effectively.

In addition, the body forming component 6 includes fixing portions 39 and 40 into which the upper contact insert component 9 is fixed. The fixing portion 39 is formed in a left rear portion of the body forming component 6, that is, in a portion located on the direction D5 side and the direction D2 side of the body forming component 6. The fixing portion 39 has an opening which is slightly narrower than a corresponding portion (fitting protrusion 61 to be described later) of the upper contact insert component 9. The fitting protrusion 61 of the upper contact insert component 9 is press-fitted into the opening, thereby fixing the upper contact insert component 9 to the body forming component 6. Although hidden in FIG. 3 and FIG. 4, similarly, the fixing portion 40 is formed in a right rear portion of the body forming component 6, that is, in a portion located on the direction D6 side and the direction D2 side of the body forming component 6. A fitting protrusion 62 to be described later is press-fitted into the fixing portion 40.

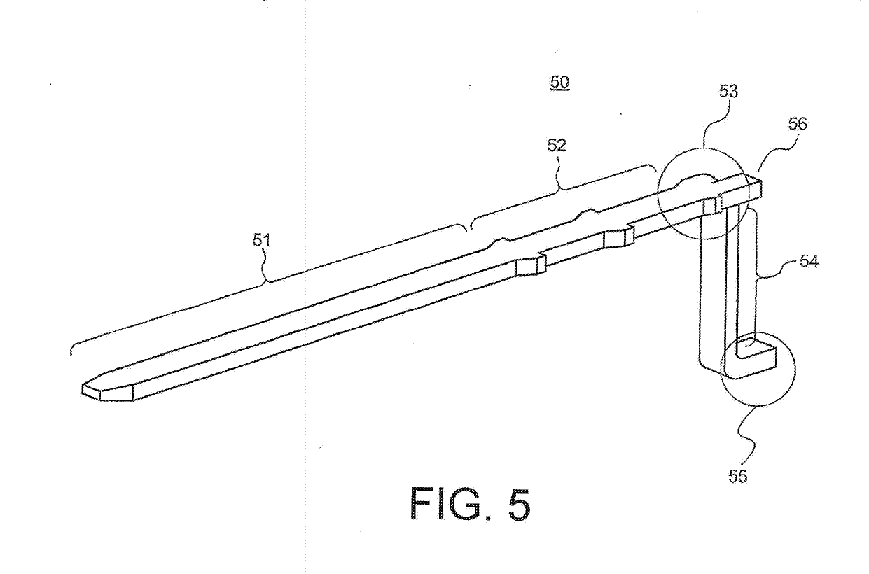

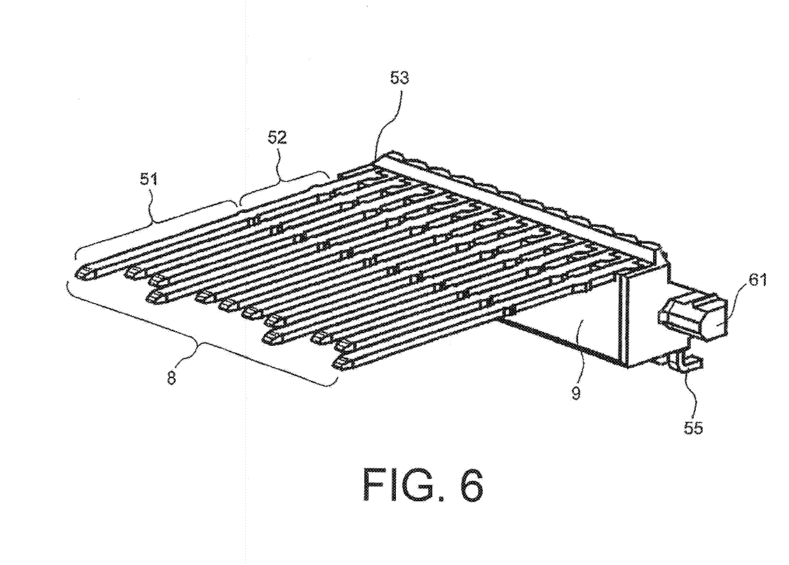

Twelve contacts 50 forming the lower contact group 7 are retained in the lower terminal insertion holes 35 and the lower terminal retention grooves 36 on the same horizontal plane at predetermined pitches so as to be parallel to each other. Further, twelve contacts 50 forming the upper contact group 8 are retained in the body forming component 6 on the same horizontal plane at predetermined pitches so as to be parallel to each other. The lower contact group 7 includes two kinds of contacts 50 different in length. The upper contact group 8 also includes two kinds of contacts 50 different in length. That is, the entire connector 1 includes four kinds of contacts 50 different in length. Each of the contacts of every kind includes a contact portion 51, a press-fitted portion 52, a bent portion 53, a leg portion 54, a terminal portion 55, and a rear end 56 (see FIG. 5 and FIG. 6).

The contacts 50 are described with reference to FIG. 5. One of the contacts 50 of the lower contact group 7 is illustrated in FIG. 5 as an example. As illustrated in FIG. 5, the contact portion 51 is arranged in parallel to a fitting direction of the connector 1, that is, directions including the direction D1 and the direction D2. The contact portion 51 is a portion to be brought into contact with a contact of a mating connector when the connector 1 is fitted to the mating connector, and the contact portion 51 is exposed from the body forming component 6. The press-fitted portion 52 is a portion to be press-fitted into and retained in the body forming component 6, and the press-fitted portion 52 is arranged in parallel to the fitting direction of the connector 1. The bent portion 53 is bent in a direction intersecting the fitting direction of the connector 1. The leg portion 54 extends toward the board in the direction bent at the bent portion 53. In this embodiment, the leg portion 54 is bent from the bent portion 53 vertically downward, that is, is bent in a direction toward the direction D4 side so as to intersect the fitting direction of the connector 1 at a right angle. However, it is not always necessary that the leg portion 54 intersect the fitting direction of the connector 1 at a right angle. For example, the leg portion 54 may be bent with rearward and downward inclination so as to intersect the fitting direction of the connector 1. The terminal portion 55 is a terminal to be connected to a conductor arranged outside the connector 1, for example, a conducting wire of a printed pattern on the board. Further, the terminal portion 55 is a terminal to be connected to the conductor, for example, through soldering. The rear end 56 is a rear end of a straight portion including the contact portion 51 and the press-fitted portion 52 and extending in parallel to the fitting direction of the connector.

Each of the contacts 50 has a shape of being bent between the contact portion 51 and the terminal portion 55 in a direction intersecting the fitting direction of the connector. In each of the contacts 50 of the lower contact group 7 as illustrated in FIG. 5, a center line of the leg portion 54 and a center line of the terminal portion 55 are slightly shifted to a right side with respect to a center line of the contact portion 51 and a center line of the press-fitted portion 52. Meanwhile, in each of the contacts 50 of the upper contact group 8, a center line of the leg portion 54 and a center line of the terminal portion 55 are shifted in an opposite direction. That is, the center line of the leg portion 54 and the center line of the terminal portion 55 are slightly shifted to a left side with respect to a center line of the contact portion 51 and a center line of the press-fitted portion 52.

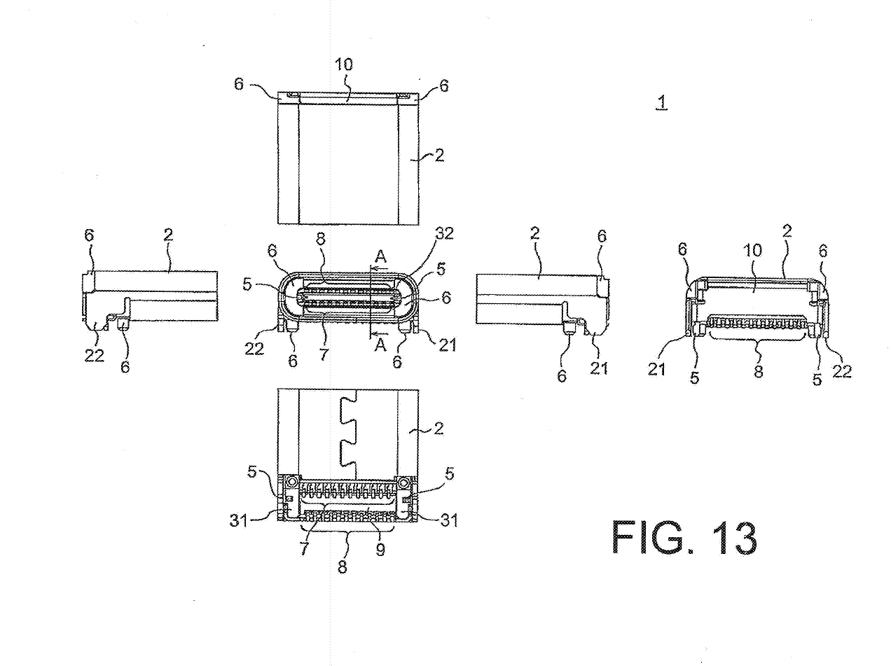

The twelve contacts of the lower contact group 7 and the twelve contacts of the upper contact group 8 are arranged so that the contact portions 51 and the press-fitted portions 52 of the contacts of both of the lower contact group 7 and the upper contact group 8 overlap each other through intermediation of the terminal support 32. However, the center lines of the leg portion 54 and the terminal portion 55 are shifted as described above. Thus, even when the contact portions 51 and the press-fitted portions 52 of the contacts overlap each other, the leg portions 54 and the terminal portions 55 are arranged so as not to overlap each other. In other words, when the connector 1 is seen from the mating connector (not shown), that is, seen in the direction D2, the leg portions 54 and the terminal portions 55 of the contacts of the upper contact group 8 are not hidden behind the leg portions 54 and the terminal portions 55 of the contacts of the lower contact group 7, but are visibly arranged (see a front view and a bottom view of FIG. 13).

The lower contact group 7 and the upper contact group 8 have the above-mentioned arrangement relationship. There is assumed such a case where forces of moving the leg portions 54 of the lower contact group 7 in the direction D2 are applied by pushing the lower contact group 7 in the direction D2. At this time, owing to the above-mentioned shifted arrangement, the leg portions 54 of the contacts of the upper contact group 8 do not restrain movement of the leg portions 54 of the contacts of the lower contact group 7 in the direction D2.

However, in the connector 1 according to this embodiment, the upper contact insert component 9 integrates the contacts of the upper contact group 8 with each other, and is arranged on the direction D2 side with respect to the leg portions 54 of the contacts of the lower contact group 7. Accordingly, the contacts of the lower contact group 7 can be restrained from moving in the direction D2.

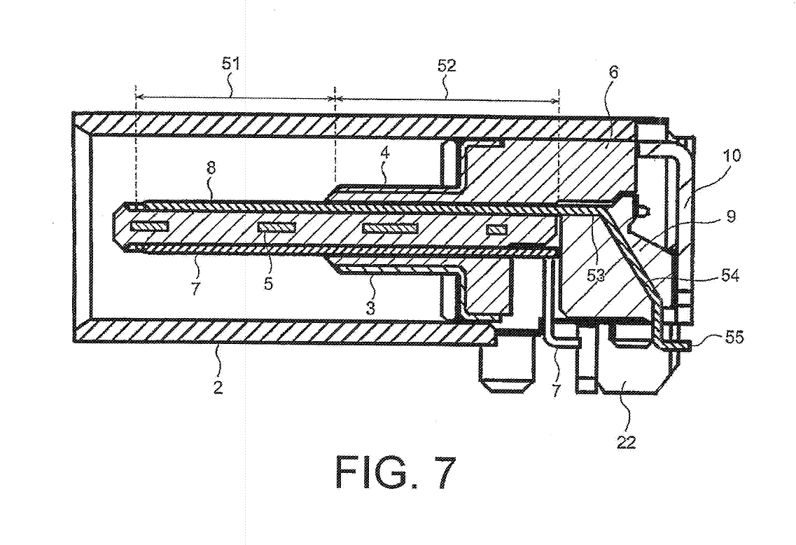

The contacts 50 are press-fitted into the body forming component 6 forward along the fitting direction of the connector 1, that is, press-fitted in the direction D1. A state of each of the contacts 50 press-fitted in the body forming component 6 is described with reference to FIG. 7. Each of the contacts 50 of the lower contact group 7 is retained in the lower terminal retention groove 36 under a state in which a lower surface of the contact portion 51, namely, a surface of the contact portion 51 on the direction D4 side is exposed. Each of the contacts 50 of the upper contact group 8 is retained in the upper terminal retention groove 38 under a state in which an upper surface of the contact portion 51, namely, a surface of the contact portion 51 on the direction D3 side is exposed. The press-fitted portion 52 of each of the contacts 50 of the lower contact group 7 is received in the lower terminal insertion hole 35. The press-fitted portion 52 of each of the contacts 50 of the upper contact group 8 is received in the upper terminal insertion hole 37. The body forming component 6 does not directly retain the bent portion 53, the leg portion 54, the terminal portion 55, and the rear end 56 of any one of the contacts 50 of the lower contact group 7 and the upper contact group 8.

However, the upper contact group 8 is formed integrally with the upper contact insert component 9 through insert molding. Thus, the contacts 50 forming the upper contact group 8 are integrated with each other, with the result that a sum of retaining forces for all of the contacts bears forces applied to the respective contacts. When the connector is fitted to the mating connector, rearward misalignment of only a part of the contacts forming the upper contact group 8 is less liable to occur. Consequently, the retaining forces for all of the contacts 50 of the upper contact group 8 can be increased.

With reference to FIG. 6, the upper contact insert component 9 is described. As illustrated in FIG. 6, the fitting, protrusions 61 and 62 are respectively formed on both left and right ends of the upper contact insert component 9, that is, on an end on the direction D5 side and an end on the direction D6 side of the upper contact insert component 9. The fitting protrusion 62 is not illustrated in FIG. 6 because the fitting protrusion 62 is hidden behind the upper contact insert component 9. When the contacts 50 of the upper contact group 8 are press-fitted into predetermined positions of the body forming component 6, the fitting protrusions 61 and 62 are arranged so as to fit into the fixing portion 39 of the body forming component 6.

As described above, in the connector 1, the contacts 50 of the upper contact group 8 are integrated in advance by the upper contact insert component 9, and are press-fitted into and retained in the body forming component 6. In addition, the upper contact insert component 9 itself retains the upper contact group 8 by being directly press-fitted into the body forming component 6. Accordingly, the retaining forces for the contacts to be applied when the upper contact group 8 is positioned with respect to the body forming component 6 can be increased.

Further, each of the contacts 50 has the structure in which the straight portion including the contact portion 51 and the press-fitted portion 52 is bent at the bent portion 53 substantially at a right angle so as to extend to a straight portion including the leg portion 54. As illustrated in FIG. 7, the upper contact insert component 9 is formed so as to cover a rear portion of the press-fitted portion 52, the bent portion 53, and the leg portion 54. In this structure, the upper contact insert component 9 is arranged so that a resin occupies a region defined by a side formed of the contact portion 51 and the press-fitted portion 52, a side formed of the leg portion 54, and a contained angle of the two sides (bent portion 53). With this structure, even when an excessive force is applied to the contact portion 51 toward the rear side of the connector 1 to misalign the rear end 56 toward the rear side with respect to a predetermined position, the resin arranged between the two sides resists the force, thereby being capable of preventing deformation of each of the contacts 50. Accordingly, the upper contact group 8 can be prevented from being buckled into a Z shape.

In addition, when the lower contact group 7 and the upper contact group 8 are press-fitted into the predetermined positions of the body forming component 6, the upper contact insert component 9 is arranged on the direction D2 side of the rear end 56 of each of the contacts 50 of the lower contact group 7.

As described above, the upper contact insert component 9 is arranged behind the lower contact group 7 so that a function of a stopper, which is configured to prevent rearward misalignment of the lower contact group 7, can be added to the upper contact insert component 9. The above-mentioned function as the stopper is exerted, for example, in a case where, when the mating connector (not shown) is fitted to the connector 1, the contacts of the mating connector apply the force of moving the contacts 50 of the lower contact group 7 toward the rear side of the connector 1.

As described above, the contacts 50 of the lower contact group 7 are press-fitted into the lower terminal insertion holes 35 and the lower terminal retention grooves 36, to thereby be retained in the body forming component 6. In a case where, during fitting between the connector and the mating connector, a force exceeding the retaining forces for the contacts is applied from the mating connector to the lower contact group 7 to move the rear end 56 of each of the contacts 50 of the lower contact group 7 to the direction D2 side from the predetermined position, the rear end 56 comes into contact with the upper contact insert component 9, to thereby prevent the rear end 56 from further moving to the direction D2 side.

It is preferred that a slight gap be defined between the rear end 56 and the upper contact insert component 9. This relates to the order of press-fitting the lower contact group 7 and the upper contact group 8 into the body forming component 6 during a manufacturing process of the connector 1.

During the manufacturing process for the connector 1, after the middle plate 5 and the body forming component 6 are formed integrally with each other through insert molding, the lower contact group 7 is first press-fitted into the body forming component 6 to be arranged at the predetermined position. Then, the distal end of the upper contact group 8 is inserted into the opening (not shown) of the rear portion of the body forming component 6, and the upper contact group 8 is pushed to the direction D1 side to be arranged at the predetermined position.

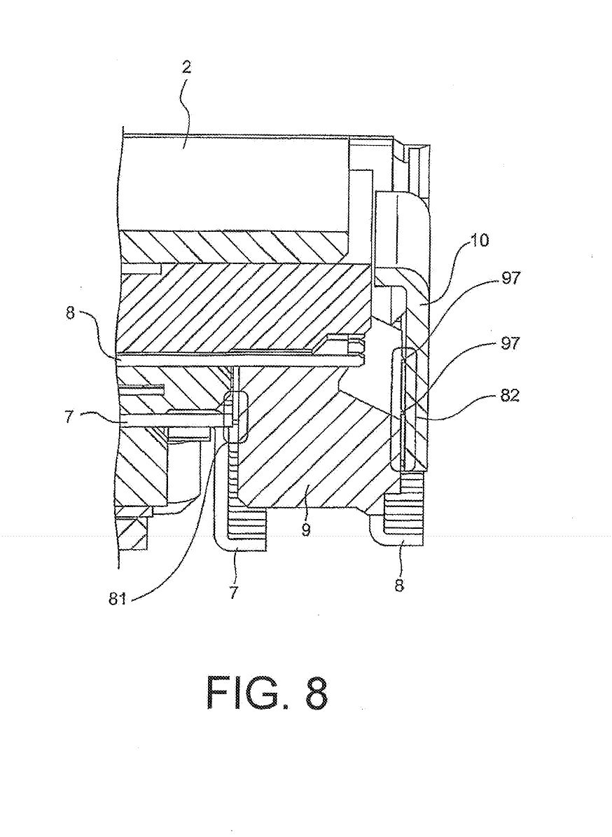

Now, there is assumed a case where the rear ends 56 of the lower contact group 7 and the upper contact insert component 9 are configured so as to come into contact with each other. In this case, at a point in time when the upper contact insert component 9 is pushed into the predetermined position, the upper contact insert component 9 comes into contact with the rear ends 56 of the lower contact group 7. In view of a positioning error and the like, movement of the upper contact insert component 9 is not always completed at the moment when the upper contact insert component 9 comes into contact with the rear ends 56 of the lower contact group 7. In actuality, the upper contact insert component 9 may be pushed to the front side of the connector with respect to the predetermined position, and the rear ends 56 of the lower contact group 7 may be arranged on the direction D2 side with respect to the predetermined position. In those cases, the upper contact insert component 9 may push the lower contact group 7 to the direction D1 side, to thereby misalign the lower contact group 7. In order to prevent misalignment of the lower contact group 7, it is preferred that a gap 81 be defined between the rear ends 56 of the lower contact group 7 and the upper contact insert component 9 as illustrated in FIG. 8. A length of the gap 81 is, for example, about 50 micrometers.

After the upper contact group 8 is arranged at the predetermined position, the ground plates 3 and 4 are mounted. Then, after the body forming component 6 into which the lower contact group 7 and the upper contact group 8 are press-fitted is accommodated in the shell 2, the rear shield 10 is fixed on the direction D2 side of the body forming component 6. In this manner, the connector 1 is completed.

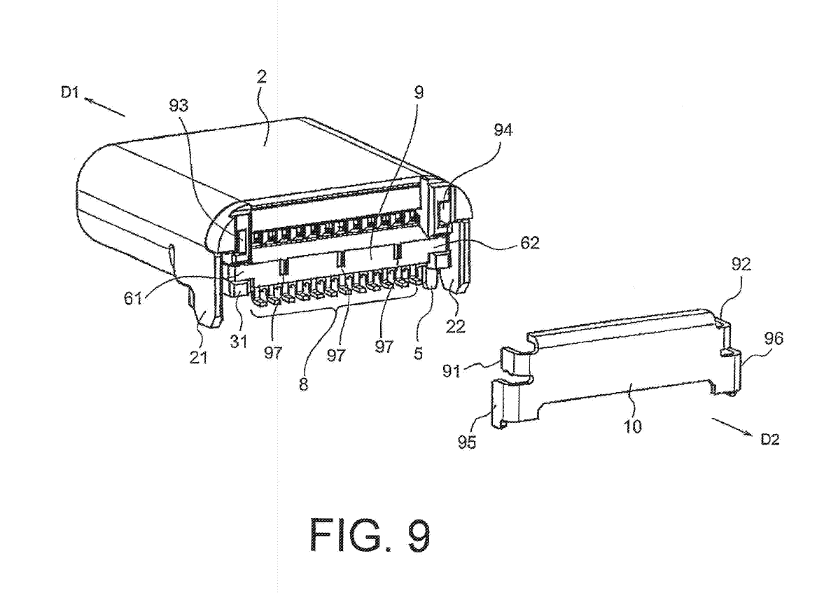

With reference to FIG. 9, the rear shield 10 is described. As illustrated in FIG. 9, press-fitting pieces 91 and 92 are formed on both left and right ends of the rear shield 10, respectively. Meanwhile, press-fitting holes 93 and 94 are formed in a back surface of the body forming component 6. The press-fitting holes 93 and 94 are configured to retain the rear shield 10 by allowing the press-fitting pieces 91 and 92 to be press-fitted into the press-fitting holes 93 and 94, respectively. An opening of the press-fitting hole 93 is slightly smaller than a cross-section of the press-fitting piece 91, and an opening of the press-fitting hole 94 is slightly smaller than a cross-section of the press-fitting piece 92. With this configuration, fixation through press-fitting can be performed.

In addition, in the connector 1, besides the press-fitting of the press-fitting pieces 91 and 92 into the press-fitting holes 93 and 94, the rear shield 10 is fixed through welding of pieces of metal.

As illustrated in FIG. 9, welding pieces 95 and 96 are respectively formed at both left and right ends of the rear shield 10 below the press-fitting pieces 91 and 92. Meanwhile, a gap is defined between a left end (end on the direction D5 side) of the base 31 of the body forming component 6 and the fixing leg portion 21 of the shell 2 and between the fitting protrusion 61 of the upper contact insert component 9 and the fixing leg portion 21 of the shell 2. When the press-fitting pieces 91 and 92 are respectively press-fitted into the press-fitting holes 93 and 94 to mount the rear shield 10 to the body forming component 6, the welding piece 95 is received in the gap. Similarly, a gap is defined between a right end (end on the direction D6 side) of the base 31 of the body forming component 6 and the fixing leg portion 22 of the shell 2 and between the fitting protrusion 62 of the upper contact insert component 9 and the fixing leg portion 22 of the shell 2. When the rear shield 10 is mounted to the body forming component 6, the welding piece 96 is received in the gap.

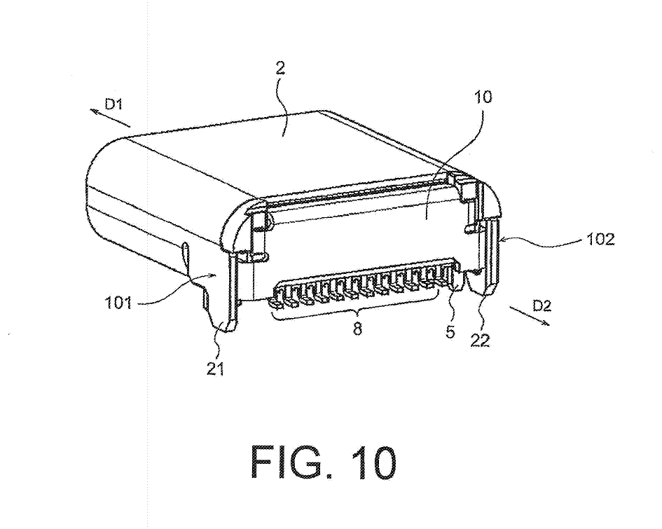

After the press-fitting pieces 91 and 92 are respectively press-fitted into the press-fitting holes 93 and 94 to mount the rear shield 10 to the body forming component 6, the fixing leg portion 21 and the welding piece 95 are welded to each other at a welded region 101 illustrated in FIG. 10. Similarly, the fixing leg portion 22 and the welding piece 96 are welded to each other at a welded region 102.

The rear shield 10 is fixed to the body forming component 6 in this manner so that the rear shield 10 retains the upper contact insert component 9 from behind. States of the upper contact insert component 9 and the rear shield 10 at this time are described.

As illustrated in FIG. 9, the upper contact insert component 9 includes three protrusions 97 on a back surface thereof. Each of the protrusions 97 has, for example, a trapezoid shape. Each of the protrusions 97 is configured to support the rear shield 10 as illustrated in FIG. 8 by coming into contact with the rear shield 10 when the rear shield 10 is fixed to the body forming component 6.

Now, the reason why the protrusions 97 are formed on the back surface of the upper contact insert component 9 is as follows.

There is assumed a case where no protrusion 97 is formed and the back surface of the upper contact insert component 9 is flat. In this case, such a configuration is ideal that the entire back surface of the upper contact insert component 9 and an entire front surface of the rear shield 10 completely come into contact with each other, in other words, a surface is supported by another surface. However, in actuality, errors such as a working error and a positioning error may occur. Thus, it is difficult for a flat surface and another flat surface to come into contact with each other, and two flat surfaces come into contact with each other with inclination. Therefore, the rear shield 10 applies a force to the upper contact insert component 9 and also to the body forming component 6 in a direction shifted from the fitting direction of the connector 1. Consequently, such an adverse influence may arise that the lower contact group 7 and the upper contact group 8 are misaligned, or that it becomes more difficult to fit the contacts to mating contacts because of the inclination of the body forming component 6.

Meanwhile, even when the protrusions 97 are formed on the back surface of the upper contact insert component 9, a working error and a positioning error may occur. However, the protrusions 97 that are a part of the upper contact insert component 9 are made of a resin. Thus, the protrusions 97 are deformed and squashed by the applied force, thereby cancelling out the errors.

As described above, according to the connector 1 of the first embodiment, the upper contact group 8 and the upper contact insert component 9 are formed integrally with each other through insert molding. With this configuration, misalignment of a part of the upper contact group 8 is prevented.

Further, as a part of the upper contact insert component 9, a resin is arranged in a region surrounded by the press-fitted portions 52, the bent portions 53, and the leg portions 54 of the upper contact group 8. With this configuration, the upper contact group 8 is prevented from being deformed into a Z shape.

Further, the front surface of the upper contact insert component 9 is arranged behind the rear ends 56 of the lower contact group 7 through a slight gap. With this configuration, even when the lower contact group 7 is misaligned rearward, the rearward misalignment of the lower contact group 7 is minimized.

Further, the upper contact insert component 9 is retained between the rear shield 10 and the body forming component 6 through press-fitting of the rear shield 10 into the body forming component 6, or through welding of the rear shield 10 to the shell 2. With this configuration, misalignment of the lower contact group 7 and the upper contact group 8 is indirectly prevented.

Further, as is apparent particularly from FIG. 7, the upper contact group 8 of the connector 1 has the structure in which a region of each contact ranging from the press-fitted portion 52 to the leg portion 54 is covered by the body forming component 6 or the resin of the upper contact insert component 9. That is, a substantially entire portion of each contact 50 excluding the contact portion 51 and the terminal portion 55, which are inevitably exposed, is covered by a resin, namely, a dielectric material. A region of the upper contact group 8 exposed to the air is small. Thus, the upper contact group 8 is covered by the dielectric material having a larger dielectric constant than the air, thereby being capable of reducing impedance.

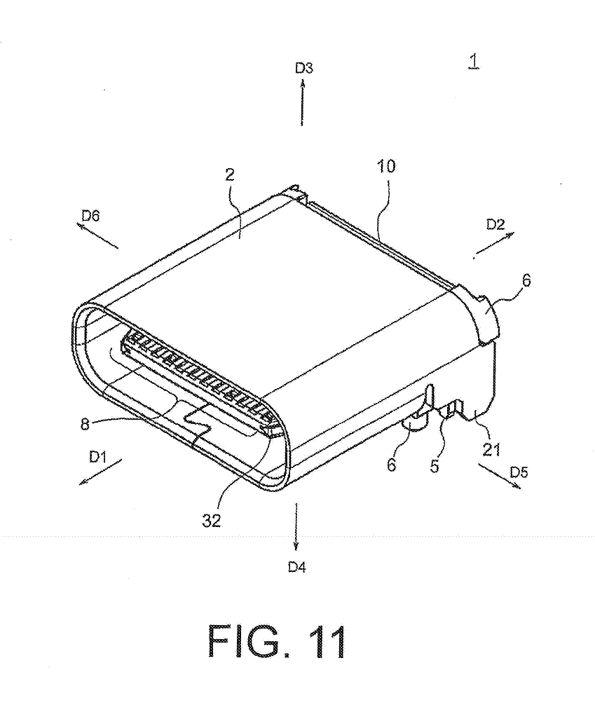

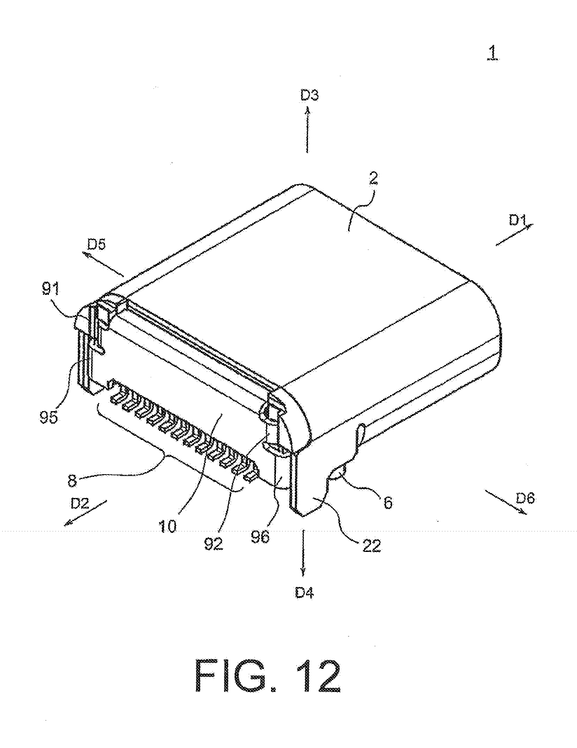

As described above, according to the connector 1 of this embodiment, the retaining forces for the lower contact group 7 and the upper contact group 8 can be increased. Finally, in aid of understanding, the assembled connector 1 is illustrated in FIG. 11 to FIG. 13.

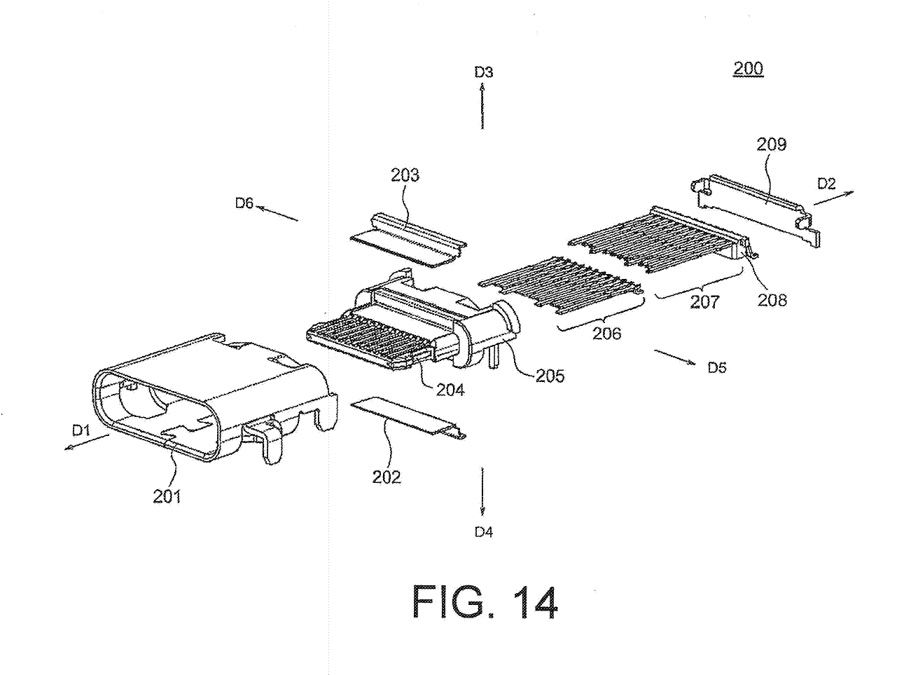

Next, a connector 200 according to a second embodiment of this invention is described. With reference to FIG. 14, the connector 200 includes a shell 201, ground plates 202 and 203, a middle plate 204, a body forming component 205, a lower contact group 206, an upper contact group 207, an upper contact insert component 208, and a rear shield 209. As is apparent from comparison to FIG. 1, the above-mentioned components respectively correspond to the components of the connector 1 represented by the same terms. In the following description, differences from the connector 1 are described. The description of the corresponding components of the connector 1 is to be referred as needed.

In the connector 1, the upper contact insert component 9 is formed so that the contacts 50 are arranged on the same plane at the predetermined pitches, and that the resin occupies the region of each of the contacts 50 surrounded by the press-fitted portion 52, the bent portion 53, and the leg portion 54.

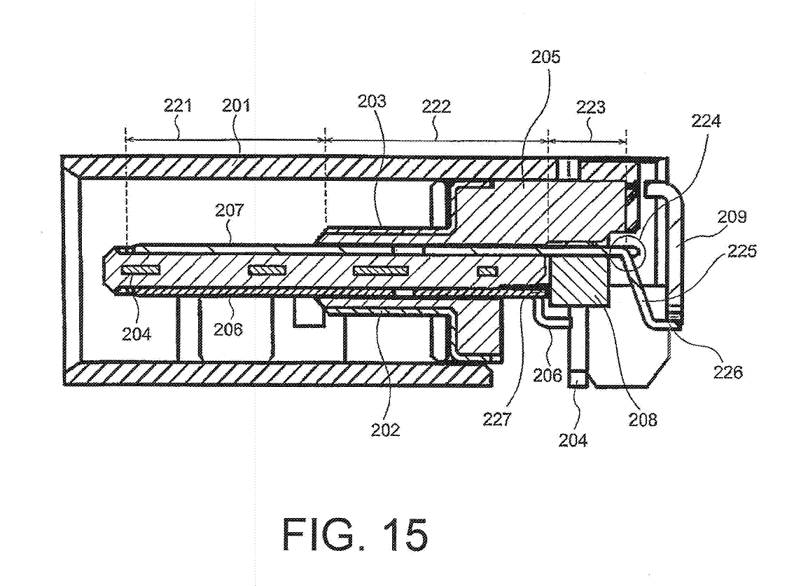

In contrast, in the connector 200, as illustrated in FIG. 15, the upper contact insert component 208 is formed so as to cover a straight portion of each of contacts between a press-fitted portion 222 and a bent portion 224, namely, an insert molding portion 223 so that the contacts are arranged on the same plane at predetermined pitches. Similarly to the connector 1, the upper contact insert component 208 is arranged on the direction D2 side of rear ends 227 of the lower contact group 206 through a slight gap. Therefore, similarly to the connector 1, the upper contact insert component 208 can exert an effect of preventing the lower contact group 206 from being misaligned to the direction D2 side.

Further, in the connector 1, the upper contact insert component 9 is supported by the rear shield 10 from the direction D2 side. In contrast, as is apparent from FIG. 15, in the connector 200, the upper contact insert component 208 is not held in contact with the rear shield 209.

According to the connector 200, similarly to the connector 1, with the structure simpler than the structure of the connector 1, the upper contact insert component 208 can integrally retain the upper contact group 207, and the upper contact insert component 208 can exert the effect of preventing rearward misalignment of the lower contact group 206.

This invention is described above with reference to some embodiments. However, it is needless to say that various modifications may be made to this invention as long as the modifications do not depart from the gist of this invention. For example, in the above-mentioned first and second embodiments, the contacts of the lower contact group 7 or 206 and the contacts of the upper contact group 8 or 208 are retained at equal pitches. However, this invention is not limited thereto. The contacts may be retained at different pitches.

This application is based on and claims the benefit of priority from Japanese Patent Application No. 2014-233685, filed on Nov. 18, 2014, the disclosure of which is incorporated herein by reference in its entirety.

### REFERENCE SIGNS LIST

1, 200 connector
2, 201 shell
3, 4, 202, 203 ground plate
5, 204 middle plate
6, 205 body forming component
7, 206 lower contact group
8, 207 upper contact group
9, 208 upper contact insert component
10, 209 rear shield
21, 22 fixing leg portion
31 base
32 terminal support
33, 34 plate support
35 lower terminal insertion hole
36 lower terminal retention groove
37 upper terminal insertion hole
38 upper terminal retention groove
39, 40 fixing portion
50 contact
51, 221 contact portion
52, 222 press-fitted portion
53, 224 bent portion
54, 225 leg portion
55, 226 terminal portion
56 227 rear end
61, 62 fitting protrusion
81, 82 gap
91, 92 press-fitting piece
93, 94 press-fitting hole
95, 96 welding piece
97 protrusion
101, 102 welded region
223 insert molding portion

1. A connector, comprising:
an upper contact group comprising a plurality of contacts;
a lower contact group comprising a plurality of contacts;
a body forming component into which the upper contact group and the lower contact group are press-fitted; and
an upper contact insert component including a dielectric material and being formed integrally with the upper contact group through insert molding,
each of the plurality of contacts being arranged in parallel to a fitting direction of fitting the connector to a mating connector, and comprising:
a contact portion that is to be brought into contact with one of contacts of the mating connector;
a press-fitted portion that extends from the contact portion and is to be press-fitted into the body forming component;
a terminal portion that is to be connected to a conductor arranged outside the connector; and
a bent portion that is bent between the contact portion and the terminal portion in a direction intersecting the fitting direction,
the each of the plurality of contacts being press-fitted into the body forming component in a direction of removing the mating connector, which is fitted to the connector in advance, from the connector,
the body forming component supporting the plurality of contacts of the lower contact group so as to arrange the contact portion of the each of the plurality of contacts of the lower contact group on a first plane, and supporting the plurality of contacts of the upper contact group, so as to arrange the contact portion of the each of the plurality of contacts of the upper contact group on a second plane different from the first plane, and
the upper contact insert component being arranged so as to restrain movement of the lower contact group in a moving direction of the mating connector toward the connector when the mating connector and the connector are to be fitted to each other.

2. The connector according to claim 1, wherein, as seen from the bent portion of the each of the plurality of contacts of the lower contact group, the upper contact insert component is arranged on a forward side of the moving direction of the mating connector toward the connector when the mating connector and the connector are to be fitted to each other.

3. The connector according to claim 1,
wherein the each of the plurality of contacts of the upper contact group comprises a leg portion extending in the direction intersecting the fitting direction, and
wherein at least a part of the upper contact insert component occupies a region surrounded by a straight line formed of the contact portion, the bent portion, and a straight line formed of the leg portion.

4. The connector according to claim 1, wherein a gap having a preset size is defined between the upper contact insert component and the lower contact group.

5. The connector according to claim 1, wherein the body forming component further comprises a middle plate that comprises metal and is formed integrally with the body forming component through insert molding so as to be arranged between the upper contact group and the lower contact group.

6. The connector according to claim 1, further comprising a rear shield including metal,
wherein the body forming component comprises a fixing portion configured to fix the rear shield under a state in which the upper contact insert component is arranged between the rear shield and the body forming component.

7. The connector according to claim 6, further comprising a protrusion formed on one surface of the upper contact insert component on the forward side of the moving direction of the mating connector toward the connector when the mating connector and the connector are to be fitted to each other so as to come into contact with the rear shield.

8. The connector according to claim 6, further comprising a shell,
wherein at least a part of the shell is formed of a conductor, and
wherein the shell and the rear shield are welded to each other.
